(19) United States
(12) Patent Application Publication
(10) Pub. No.: US 2013/0077021 A1
(43) Pub. Date: Mar. 28, 2013

(54) DISPLAY DEVICE

(71) Applicants: Yutaka Nakai, Kanagawa-ken (JP); Tsuyoshi Hioki, Tokyo (JP)

(72) Inventors: Yutaka Nakai, Kanagawa-ken (JP); Tsuyoshi Hioki, Tokyo (JP)

(73) Assignee: KABUSHIKI KAISHA TOSHIBA, Tokyo (JP)

(21) Appl. No.: 13/490,643

(22) Filed: Jun. 7, 2012

(30) Foreign Application Priority Data
Sep. 27, 2011 (JP) 2011-210315

(51) Int. Cl. G02F 1/13357; F21V 8/00

(52) U.S. Cl. 349/62; 362/602

(57) ABSTRACT

According to one embodiment, a display device includes light guide bodies, light sources, light extraction units, and a control unit. Each light guide body includes one end, another end on an opposite side, and a side surface. The light guide bodies are disposed with a pitch. Each of the light sources is juxtaposed to the one end of each light guide body and configured to cause a light to enter the light guide bodies. Each light extraction unit faces the side surface. Each light extraction unit includes light extraction elements. The control unit is configured to supply an electric signal to each light extraction unit. The control unit makes the light extraction units extract the light that enters the light guide bodies and propagates through the light guide bodies in accordance with the electric signal. Positions between the light extraction elements are uniformly distributed.

### CROSS-REFERENCE TO RELATED APPLICATIONS

This application is based upon and claims the benefit of priority from the prior Japanese Patent Application No. 2011-210315, filed on Sep. 27, 2011; the entire contents of which are incorporated herein by reference.

### FIELD

Embodiments described herein relate generally to a display device.

### BACKGROUND

These days, a display device using a light guide structure is proposed. The display device includes, for example, a plurality of light sources disposed in a line, a plurality of light guide bodies connected one by one to the light sources, and a plurality of light extraction units provided on the surface of each light guide body. The light extraction and non-extraction from the surface of each light guide body are controlled by changing the light extraction unit physically or chemically. Thereby, the display device can display an image. In such a display device, it is important to reduce display unevenness to perform uniform displaying.

### BRIEF DESCRIPTION OF THE DRAWINGS

FIG. 1 is a schematic plan view showing a display device according to a first embodiment;

FIG. 2 is a schematic cross-sectional view showing the display device according to the first embodiment;

FIG. 3 is a schematic view showing the display device according to the first embodiment;

FIG. 4 is a schematic plan view showing a part of the display device according to the first embodiment;

FIG. 5 is a schematic plan view showing a display device of a first reference example;

FIG. 6 is a schematic plan view showing a display device of a second reference example;

FIG. 7 is a schematic plan view showing the display device according to the first embodiment;

FIG. 8A, FIG. 8B, FIG. 8C, FIG. 9A, FIG. 9B, FIG. 9C, FIG. 10A, FIG. 10B, FIG. 10C, FIG. 11A, FIG. 11B, FIG. 11C, FIG. 12A, FIG. 12B, and FIG. 12C are schematic diagrams showing display unevenness in the display device;

FIG. 13 is a schematic cross-sectional view showing a display device according to a second embodiment;

FIG. 14 is a schematic view showing the display device according to the second embodiment;

FIG. 15 is a schematic plan view showing a part of the display device according to the second embodiment; and

FIG. 16 is a schematic plan view showing a part of another display device according to the second embodiment.

### DETAILED DESCRIPTION

According to one embodiment, a display device includes a plurality of light guide bodies, a plurality of light sources, a plurality of light extraction units, and a control unit. The light guide bodies extend along a first direction. Each of the light guide bodies includes one end, another end on an opposite side to the one end, and a side surface extending along the first direction from. The light guide bodies are disposed along a second direction orthogonal to the first direction with a pitch. Each of the plurality of light sources is juxtaposed to the one end of each of the light guide bodies. The light sources are configured to cause a light to enter the light guide bodies from the one end. Each of the plurality of light extraction units faces the side surface of each of the light guide bodies. Each of the light extraction units includes a plurality of light extraction elements disposed along the second direction. The light extraction units are disposed along the first direction. The control unit is configured to supply an electric signal to each of the light extraction units. The control unit makes the light extraction units extract the light that enters the light guide bodies and propagates through the light guide bodies, from the light guide bodies to an outside of the light guide bodies in accordance with the electric signal. A length along the second direction of the light extraction elements is twice or more the pitch. Positions between the light extraction elements are uniformly distributed in a plane including the first direction and the second direction.

Various embodiments will be described hereinafter with reference to the accompanying drawings.

The drawings are schematic or conceptual; and the relationships between the thickness and width of portions, the proportions of sizes among portions, etc. are not necessarily the same as the actual values thereof. Further, the dimensions and proportions may be illustrated differently among drawings, even for identical portions.

In the specification of this application and the drawings, components similar to those described in regard to a drawing thereinabove are marked with the same reference numerals, and a detailed description is omitted as appropriate.

### First Embodiment

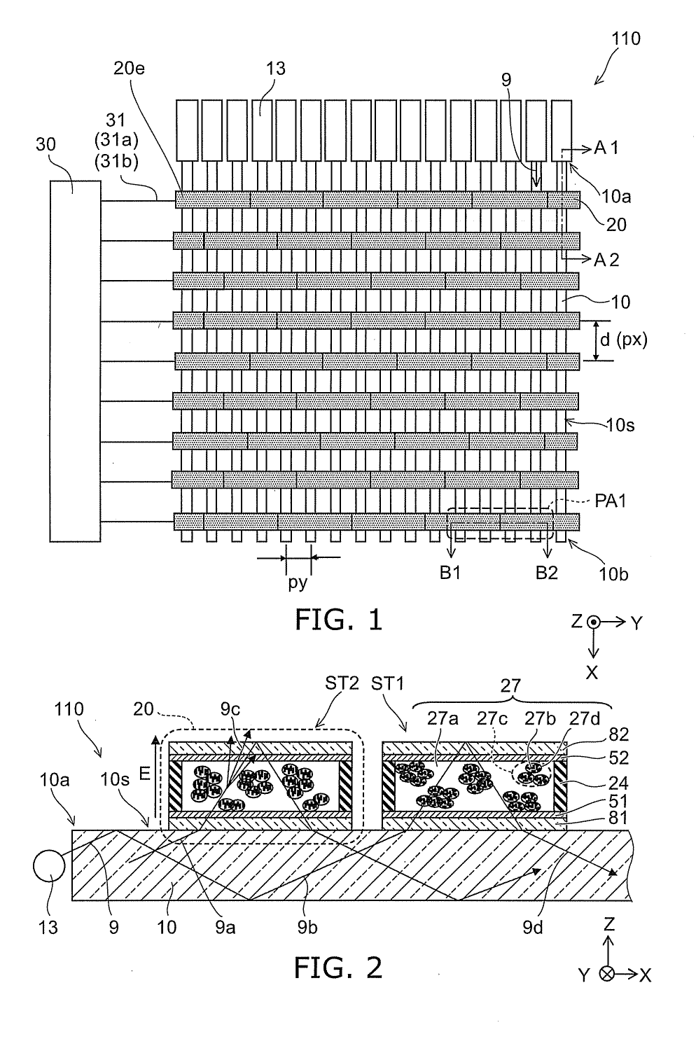

FIG. 1 is a schematic plan view illustrating the configuration of a display device according to a first embodiment.

As shown in FIG. 1, a display device 110 according to the embodiment includes a plurality of light guide bodies 10, a plurality of light sources 13, a plurality of light extraction units 20, and a control unit 30.

Each of the plurality of light guide bodies 10 extends along a first direction. The plurality of light sources 13 are disposed along a second direction. The second direction is orthogonal to the first direction. An axis parallel to the first direction is defined as the X-axis. One axis perpendicular to the X-axis direction is defined as the Y-axis. The axis perpendicular to the X-axis and the Y-axis is defined as the Z-axis.

The axis along which the light guide body 10 extends is the X-axis. The plurality of light guide bodies 10 are disposed along the Y-axis with, for example, a pitch py (a pitch of the arrangement). Each of the plurality of light guide bodies 10 includes one end 10a, another end 10b on the opposite side to the one end, and a side surface 10s. The side surface extends along the X-axis. The direction from the one end 10a toward the other end 10b is the X-axis direction.

Each of the plurality of light sources 13 is juxtaposed to the one end 10a of each of the plurality of light guide bodies 10. For example, the light source 13 faces the one end 10a. The light source 13 causes light 9 to enter the light guide body 10 from the one end 10a of the light guide body 10. The light 9 is propagated through the light guide body 10 from the one end 10a toward the other end 10b.

Each of the plurality of light extraction units 20 extends along, for example, the Y-axis (the second direction). Each of the plurality of light extraction units 20 faces the side surface 10s of each of the plurality of light guide bodies 10. Each of the plurality of light extraction units 20 includes a plurality of light extraction elements 20e. The plurality of light extraction elements 20e are disposed along the Y-axis. The plurality of light extraction units 20 are disposed along the X-axis. The plurality of light extraction units 20 are disposed with, for example, a pitch px.

The control unit 30 is electrically connected to each of the plurality of light extraction units 20 by, for example, an interconnection (including a supply line 31 described later) etc. The control unit 30 supplies an electric signal to each of the plurality of light extraction units 20.

The light extraction unit 20 extracts the light 9 propagated through the light guide body 10 from the light guide body 10 to the outside of the light guide body 10 in accordance with the electric signal. That is, the control unit 30 makes the plurality of light extraction units 20 extract the light 9 that has been injected into the light guide body 10 and is propagated through the light guide body 10 from the light guide body 10 to the outside of the light guide body 10 in accordance with the electric signal.

Thus, the plurality of light sources 13 are arranged in one direction (the Y-axis direction). The plurality of light guide bodies 10 extend in a direction (the X-axis direction) almost orthogonal to the one direction. The light guide body 10 is, for example, joined to each light source 13. The plurality of light guide bodies 10 are, for example, in columnar shapes extending along the X-axis. The plurality of light extraction units 20 are provided to face the side surfaces 10s of the light guide bodies 10. The spacing d (the pitch px along the X-axis) between the centers of light extraction units 20 corresponds to, for example, the pixel spacing.

In the embodiment, each of intersection portions between the light extraction units 20 and the plurality of light guide bodies 10 forms one pixel. However, the embodiment is not limited thereto, and one pixel may include a plurality of intersection portions.

M (M being an integer of 2 or more) light sources 13 are disposed in the horizontal direction (the Y-axis direction), for example. The light guide body 10 extends in the vertical direction (the X-axis direction). Each of the light extraction units 20 extends in the horizontal direction. For each of the light guide bodies 10, N (N being an integer of 2 or more) light extraction units 20 are arranged along the vertical direction. Thus, pixels are arranged M in number in the horizontal direction and N in number in the vertical direction. The light extraction unit 20 is taken as one line. An image can be displayed by, for example, scanning the pixels while sequentially switching on a line basis from the first line at the top in the vertical direction to the N-th line at the bottom.

In the displaying of the i-th (i=1 to N) line, the image data of the i-th line are supplied to the light source 13. Thereby, each light source 13 emits light 9 with an intensity and color corresponding to the image data of the i-th line. The light 9 is propagated through the corresponding light guide body 10 in the vertical direction.

In synchronization with the light 9, a drive signal (an electric signal) is supplied from the control unit 30 to the light extraction unit 20 of the i-th. The light extraction unit 20 supplied with the drive signal is switched to the light extraction state. That is, the light extraction unit 20 of the i-th in the vertical direction is switched to the light extraction state. No drive signal is given to the light extraction units 20 other than the i-th, and the other light extraction units 20 are in the non-extraction state.

By supplying such a drive signal, the light 9 propagated through the light guide body 10 (corresponding to the image data of the i-th line) is extracted from the light extraction unit 20 of the i-th. After a prescribed time, the control unit 30 selects the light extraction unit 20 of the (i+1)-th and supplies a drive signal thereto, while supplying the image data of the (i+1)-th line to the light source 13. Thereby, the light 9 corresponding to the image date of the (i+1)-th is extracted from the light extraction unit 20 of the (i+1)-th.

The light extracted from the light guide body 10 to the outside of the light guide body 10 by the light extraction unit 20 is emitted along, for example, a direction including a Z-axis component. That is, the X-Y plane in which the plurality of light guide bodies 10 and the plurality of light extraction units 20 intersect serves as a display surface.

An example of the mechanism by which the light 9 is extracted by supplying a drive signal to the light extraction unit 20 will now be described.

FIG. 2 is a schematic cross-sectional view illustrating the configuration of the display device according to the first embodiment.

FIG. 2 is a cross-sectional view taken along line A1-A2 of FIG. 1.

As shown in FIG. 2, the light extraction unit 20 includes, for example, a transparent first substrate 81, a transparent second substrate 82, a first electrode 51, a second electrode 52, and a liquid crystal dispersion layer 27. The second substrate 82 faces the first substrate 81 along the Z-axis, for example. The first electrode 51 is disposed between the first substrate 81 and the second substrate 82. The second electrode 52 is disposed between the first electrode 51 and the second substrate 82. The liquid crystal dispersion layer 27 is disposed between the first electrode 51 and the second electrode 52.

The first substrate 81 faces the side surface 10s of the light guide body 10, for example. In the example, the first substrate 81 is provided on the light guide body 10. The first electrode 51 is provided on the first substrate 81. The liquid crystal dispersion layer 27 is provided on the first electrode 51. The second electrode 52 is provided on the liquid crystal dispersion layer 27. The second substrate 82 is provided on the second electrode 52. In the specific example, a seal member 24 is further provided. The seal member 24 surrounds the liquid crystal dispersion layer 27 between the first electrode 51 and the second electrode 52 (possibly between the first substrate 81 and the second substrate 82).

The liquid crystal dispersion layer 27 includes, for example, a porous body 27a and polymer dispersed liquid crystal units 27b. The porous body 27a includes, for example, pores 27c. The average of the diameter of the pores 27c is, for example, 500 nanometers (nm). The porous body 27a is transmissive to light. The polymer dispersed liquid crystal unit 27b is provided in the pore 27c of the porous body 27a. In the liquid crystal dispersion layer 27, for example, a liquid crystal system called a polymer dispersed liquid crystal (PDLC) is employed.

As the porous body 27a, for example, a film-like porous body etc. are used. For the polymer dispersed liquid crystal unit 27b, a material in which a liquid crystal material and a transparent material curable by heat or ultraviolet light are mixed is used. Thereby, liquid crystal droplets 27d are formed. As the transparent material curable by heat or ultraviolet light, for example, an ultraviolet curable resin etc. are used. The ultraviolet curable resin is placed in an uncured state and then cured. As the liquid crystal material, a material in which the orientations of liquid crystal molecules are uniformly directed in an electric field is used, for example, a nematic liquid crystal is used. The mixing ratio of the liquid crystal material and the transparent material is determined depending on the materials, and is set within a range in which the liquid crystal material forms the liquid crystal droplet 27d easily.

The first electrode 51 and the second electrode 52 face each other along the direction (the Z-axis direction) perpendicular to the side surface 10s of the light guide body 10. The first electrode 51 and the second electrode 52 hold the liquid crystal dispersion layer 27. A transparent electrode, for example, is used as the first electrode 51 and the second electrode 52. The first substrate 81 and the second substrate 82 hold the first electrode 51 and the second electrode 52, respectively. The first electrode 51 is connected to, for example, the control unit 30, and the second electrode 52 is grounded. A voltage is applied between the first electrode 51 and the second electrode 52 by the control unit 30.

The pores 27c provided in the porous body 27a are formed to be scattered in the porous body 27a. The average of the diameter of the pores 27c is, for example, 500 nm. The average of the diameter of the liquid crystal droplets 27d is, for example, 50 nm. In a state where an electric field E is not generated, the refractive index of the porous body 27a and the average refractive index of the polymer dispersed liquid crystal units 27b existing in the pores 27c of the porous body 27a are set substantially equal. Consequently, the polymer dispersed liquid crystal unit 27b does not exhibit light scattering, and the liquid crystal dispersion layer 27 is in a transparent state.

A transparent conductive material such as ITO (indium tin oxide), for example, is used for the first electrode 51 and the second electrode 52. A transparent insulating material such as polyethylene terephthalate (PET), a polycarbonate, and an acrylic resin, for example, is used for the first substrate 81 and the second substrate 82. A material such as an epoxy resin, for example, is used for the seal member 24. An acrylic resin and the like, for example, are used for the light guide body 10.

When a light extraction unit 20 is selected by the control unit 30, a voltage is applied between the first electrode 51 and the second electrode 52 of the light extraction unit 20, and an electric field E is generated in the liquid crystal dispersion layer 27.

In the light extraction unit 20 on the right side shown in FIG. 2 (a first state ST1), no voltage is applied between the first electrode 51 and the second electrode 52. In the first state ST1, the liquid crystal dispersion layer 27 is transparent. At this time, when the light 9b traveling through the light guide body 10 while being totally reflected reaches a portion on the side surface 10s of the light guide body 10 where the light extraction unit 20 is provided, the light 9b passes through the liquid crystal dispersion layer 27 to be totally reflected at the second substrate 82. The totally reflected light 9d passes through the liquid crystal dispersion layer 27 again, and is returned to the light guide body 10.

On the other hand, in the light extraction unit 20 on the left side shown in FIG. 2 (a second state ST2), a voltage is applied between the first electrode 51 and the second electrode 52. In the second state ST2, an electric field E is generated in the liquid crystal dispersion layer 27, and (e.g. the major axes of) liquid crystal molecules are oriented along the Z-axis. At this time, the refractive index of the polymer dispersed liquid crystal unit 27b changes from the refractive index when the electric field E is not generated. Thereby, a difference occurs between the refractive index of the polymer dispersed liquid crystal unit 27b and the refractive index of the porous body 27a, and the liquid crystal dispersion layer 27 becomes a scattering state.

In the scattering state, the light 9a traveling through the light guide body 10 reaches a portion of the side surface 10s of the light guide body 10 where the light extraction unit 20 is provided, and the light 9a passes through the liquid crystal dispersion layer 27. At this time, light scattering occurs in the liquid crystal dispersion layer 27. Of the light scattered in the liquid crystal dispersion layer 27, light 9c of which the incident angle to the interface between the second substrate 82 and the outside is smaller than the critical angle is refracted, and is emitted to the outside of the light extraction unit 20.

Thus, by controlling the voltage between the first electrode 51 and the second electrode 52, the orientation of the liquid crystal material of the liquid crystal dispersion layer 27 can be controlled, and the extraction and non-extraction of the light propagated through the light guide body 10 can be switched to each other.

The response speed to the electric field E of the liquid crystal material depends on the diameter (size) of the liquid crystal droplet 27d in the polymer dispersed liquid crystal unit 27b. In the case where the average of the diameter of the liquid crystal droplets 27d is not more than 100 nm, a high-speed response of 100 μs (microseconds) or less is obtained.

The control unit 30 controls the light extraction and non-extraction of the plurality of light extraction units 20 by sequentially scanning the plurality of light extraction units 20. Thereby, an image is displayed in the display device 110.

The seal member 24 suppresses contact of the liquid crystal dispersion layer 27 with air which leads to a reduction in reliability. The seal member 24 is provided as necessary and may be omitted. By using a light absorbing material as the seal member 24, light leakage from the liquid crystal dispersion layer 27 through the seal member 24 can be suppressed in the light non-extraction state, and the image quality of the display device 110 is improved.

The inventors of this application have found that display unevenness occurs in a display device having a configuration like the above.

For example, it has been found that, if the length (the length along the Y-axis direction) of the light extraction unit 20 is excessively long, the display state may be different between the one end side and the other end side of the light extraction unit 20. As a result of an analysis of this, it has been found that the display unevenness is due to the fact that, when a drive voltage is supplied from one end of the light extraction unit 20, signal delay occurs that is mainly caused by the electric resistance of the first electrode 51 and the second electrode 52 and the electric capacitance of the liquid crystal dispersion layer 27. That is, the drive voltage waveform becomes duller with distance from the end to which the drive voltage is applied, and consequently a phenomenon occurs in which the light extraction timing of the light extraction unit 20 is shifted. The phenomenon is significantly observed particularly when the electric resistance of the ITO used as the electrode is high and thus the time constant is large.

In the display device 110 according to the embodiment, to suppress display unevenness caused by the signal delay, a conductive layer (an electrode and an interconnection) for supplying a current is provided for the electrode (the first electrode 51 and the second electrode 52) by which a voltage is applied to the liquid crystal dispersion layer 27.

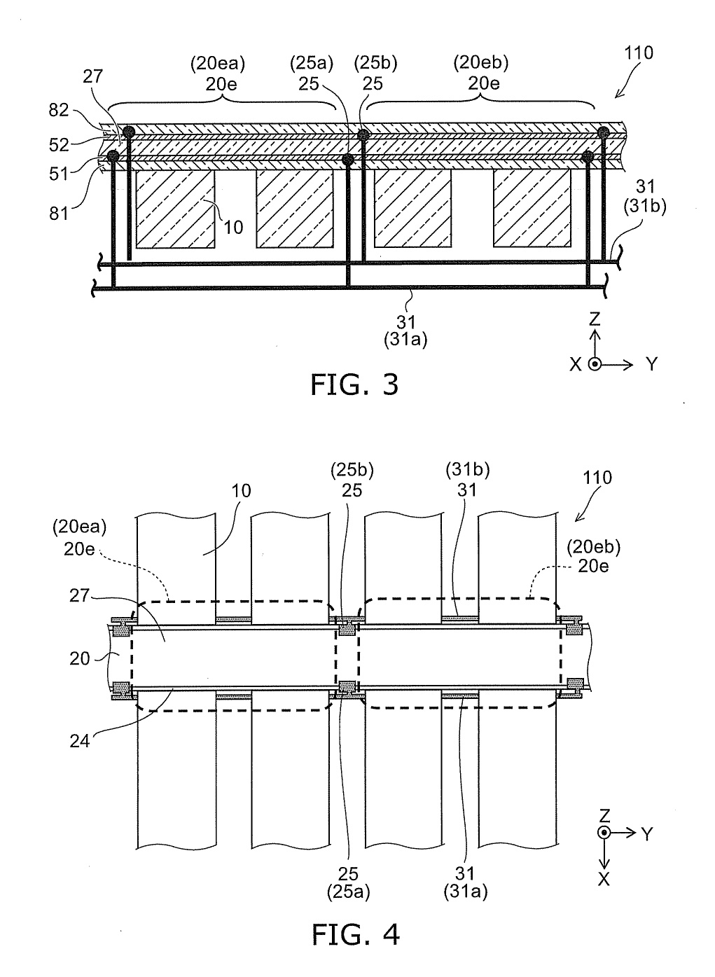

FIG. 3 is a schematic view illustrating the configuration of the display device according to the first embodiment.

FIG. 3 schematically illustrates a cross section taken along line B1-B2 of FIG. 1.

As shown in FIG. 3, the display device 110 according to the embodiment includes a lead electrode 25 (a first lead electrode 25a and a second lead electrode 25b). The first lead electrode 25a is in contact with the side surface of the first electrode 51. The second lead electrode 25b is in contact with the side surface of the second electrode 52. The first lead electrode 25a and the second lead electrode 25b thus configured are provided in plural along the Y-axis direction. That is, the plurality of first lead electrodes 25a and the plurality of second lead electrodes 25b are provided so that a current can be supplied to the first electrode 51 and the second electrode 52 from a plurality of intermediate positions of the light extraction unit 20 along the extending direction of the light extraction unit 20.

The position along the Y-axis of the first lead electrode 25a is located in the space between light guide bodies 10. The spacing between first lead electrodes 25a is longer than the pitch py along the Y-axis direction of the plurality of light guide bodies 10. The spacing between first lead electrodes 25a is a two or more integral multiple of the pitch py along the Y-axis direction of the plurality of light guide bodies 10. The spacing between the plurality of first lead electrodes 25a is a 100 or less integral multiple of the pitch py.

Similarly, the position along the Y-axis of the second lead electrode 25b is located in the space between light guide bodies 10. The spacing between second lead electrodes 25b is longer than the pitch py along the Y-axis direction of the plurality of light guide bodies 10. The spacing between second lead electrodes 25b is a two or more integral multiple of the pitch py along the Y-axis direction of the plurality of light guide bodies 10. The spacing between the plurality of second lead electrodes 25b is a 100 or less integral multiple of the pitch py.

A supply line 31 attached to the light extraction unit 20 is connected to the lead electrode 25. Specifically, a first supply line 31a attached to the light extraction unit 20 is connected to the first lead electrode 25a. A second supply line 31b attached to the light extraction unit 20 is connected to the second lead electrode 25b. The supply line 31 (the first supply line 31a and the second supply line 31b) supplies an electric signal to each of the plurality of light extraction elements 20e. A low resistive metal interconnection of aluminum, copper, and the like, for example, may be used as the supply line 31. To suppress luster, these metal interconnections may be coated with a resin or the like.

FIG. 4 is a schematic plan view illustrating the configuration of a part of the display device according to the first embodiment. FIG. 4 illustrates an enlarged view of a part PA1 of FIG. 1.

As shown in FIG. 4, in the example, the light extraction unit 20 is disposed between the first supply line 31a and the second supply line 31b. The liquid crystal dispersion layer 27 is disposed between the first lead electrode 25a and the second lead electrode 25b.

By providing the lead electrode 25 and the supply line 31 thus configured, the resistance of the electrode of the light extraction unit 20 can be reduced to decrease the interconnect time constant, and delay in light extraction timing can be suppressed.

The liquid crystal dispersion layer 27 is put in between the first electrode 51 and the second electrode 52 by, for example, penetration. At this time, if the length along the Y-axis of the light extraction unit 20 is excessively long, it takes an enormous amount of time to charge a liquid crystal from an end of the light extraction unit 20. In view of this, minute spaces are formed in portions of the seal member 24 corresponding to the positions of the lead electrodes 25; a liquid crystal is injected and charged through the spaces; and then the spaces are sealed with a resin. Thereby, the time required for liquid crystal charge can be reduced.

By providing the light extraction unit 20 with the lead electrode 25 as described above, the light extraction unit 20 is provided with a minute but optically different matter. This applies also to the case where the position for liquid crystal injection is provided as mentioned above.

In other words, as shown in FIG. 3 and FIG. 4, the light extraction unit 20 consequently includes a plurality of light extraction elements 20e (e.g. a first light extraction element 20ea, a second light extraction element 20eb, etc.) partitioned by an optically different matter. The plurality of light extraction elements 20e are electrically connected to one another by the lead electrode 25 etc. Thus, it can be recognized that the light extraction unit 20 has a structure in which the plurality of light extraction elements 20e disposed along the Y-axis direction are connected.

It has been found that display unevenness occurs in the case where the plurality of light extraction elements 20e are further provided in this way. An analysis of the phenomenon has revealed that the display unevenness depends on the arrangement in the display surface (in the X-Y plane) of the connection points between light extraction elements 20e. The connection point is, for example, the place where the lead electrode 25 mentioned above is provided. That is, as a new issue, it has been discovered that display unevenness due to the connection points occurs.

Examples of the relationship between the configuration of the light extraction elements 20e (corresponding to the arrangement of connection points) and display unevenness will now be described.

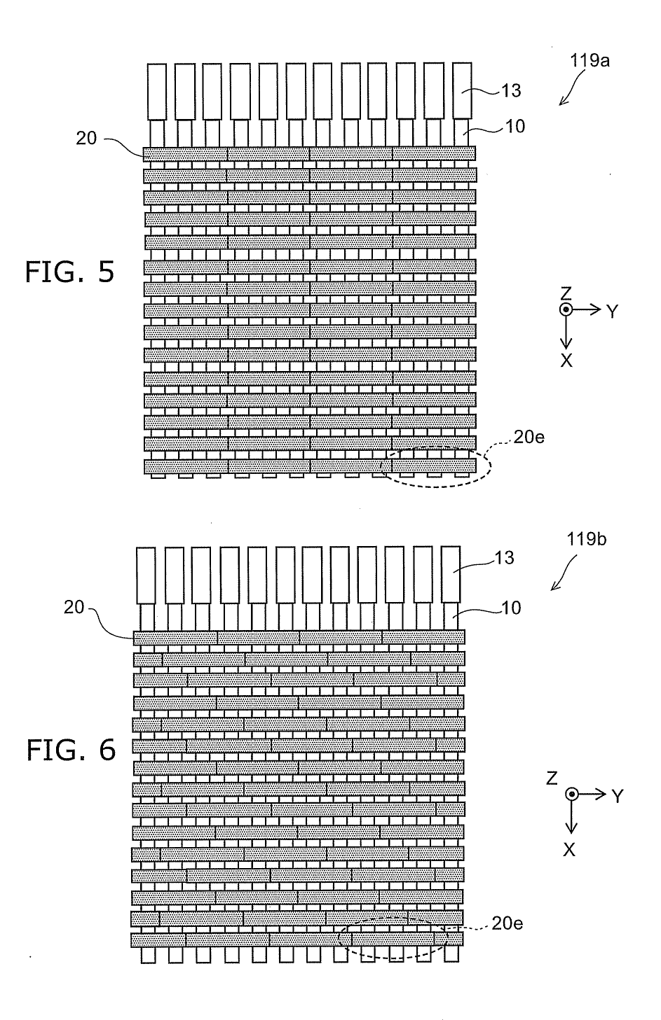

FIG. 5 is a schematic plan view illustrating the configuration of a display device of a first reference example.

As shown in FIG. 5, in a display device 119a of the first reference example, the light extraction element 20e included in the light extraction unit 20 has a length of three pixels. The connection points between light extraction elements 20e are in a common place in the row direction (the Y-axis direction). As a result, strong stripes in the vertical direction (the X-axis direction) due to the connection points are sighted in the display surface.

FIG. 6 is a schematic plan view illustrating the configuration of a display device of a second reference example.

As shown in FIG. 6, in a display device 119b of the second reference example, the connection points between light extraction elements 20e are disposed to be each shifted by one column. In this case, strong stripes occur in an oblique direction.

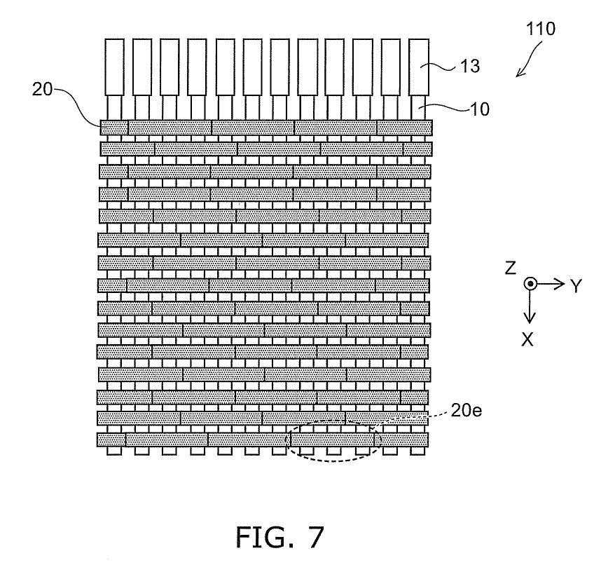

FIG. 7 is a schematic plan view illustrating the configuration of the display device according to the first embodiment.

As shown in FIG. 7, in the display device 110 according to the embodiment, the connection points between light extraction elements 20e are uniformly arranged in the row direction. For example, the connection points between light extraction elements 20e are randomly arranged. Thereby, display unevenness such as stripes etc. due to the connection points between light extraction elements 20e is suppressed.

Herein, “uniform” refers to a state where there is no regularity such as periodicity and no local unevenness in existence density either, in the display surface.

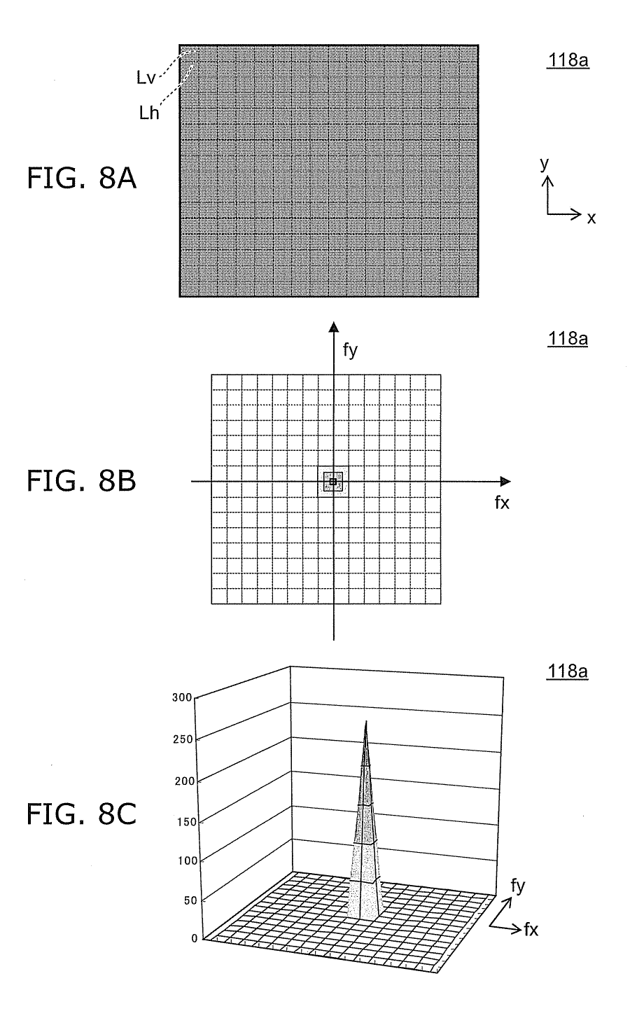

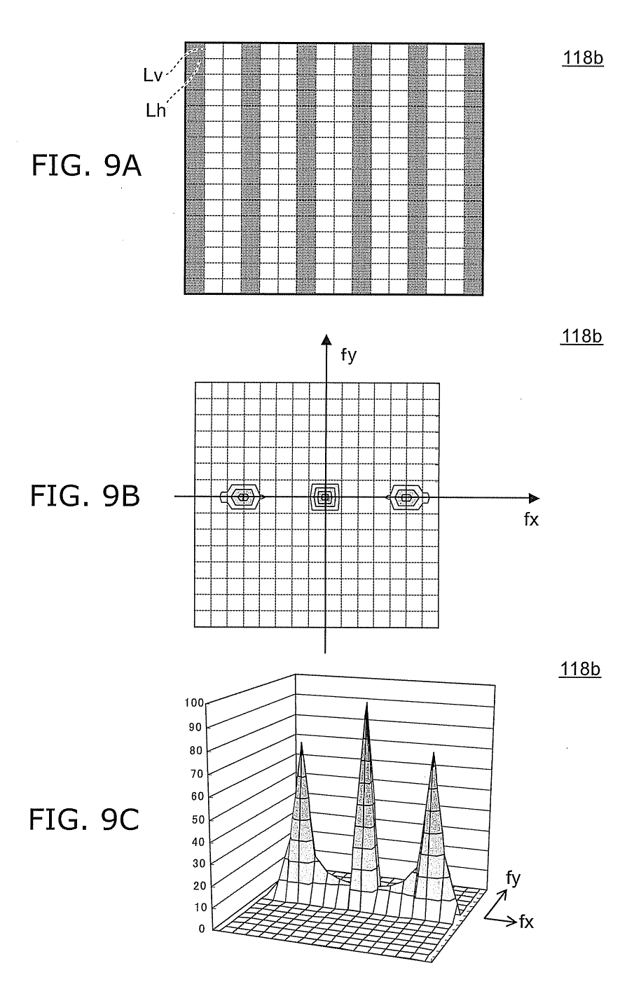

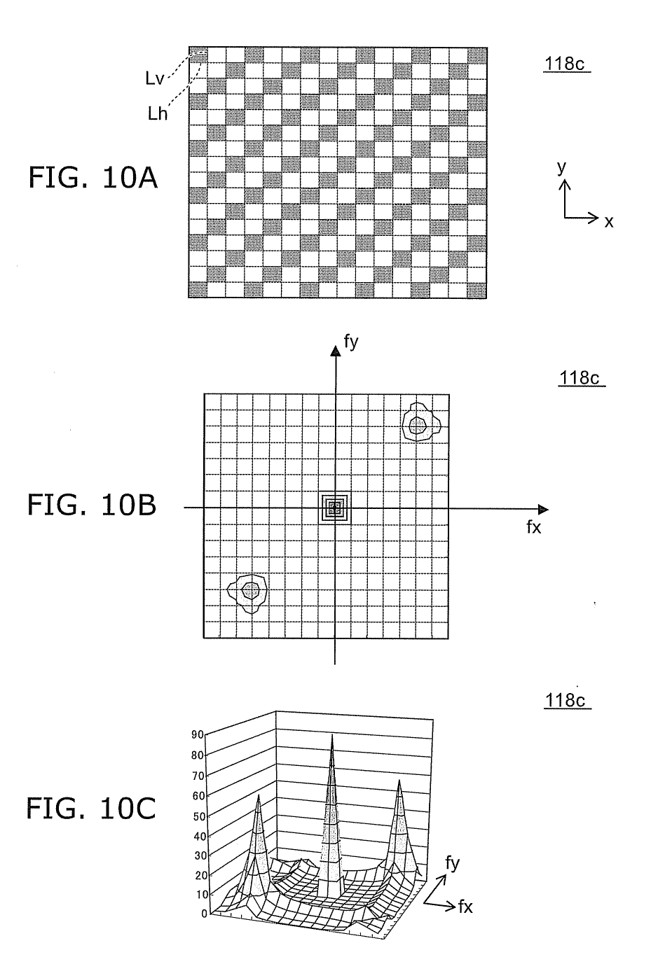

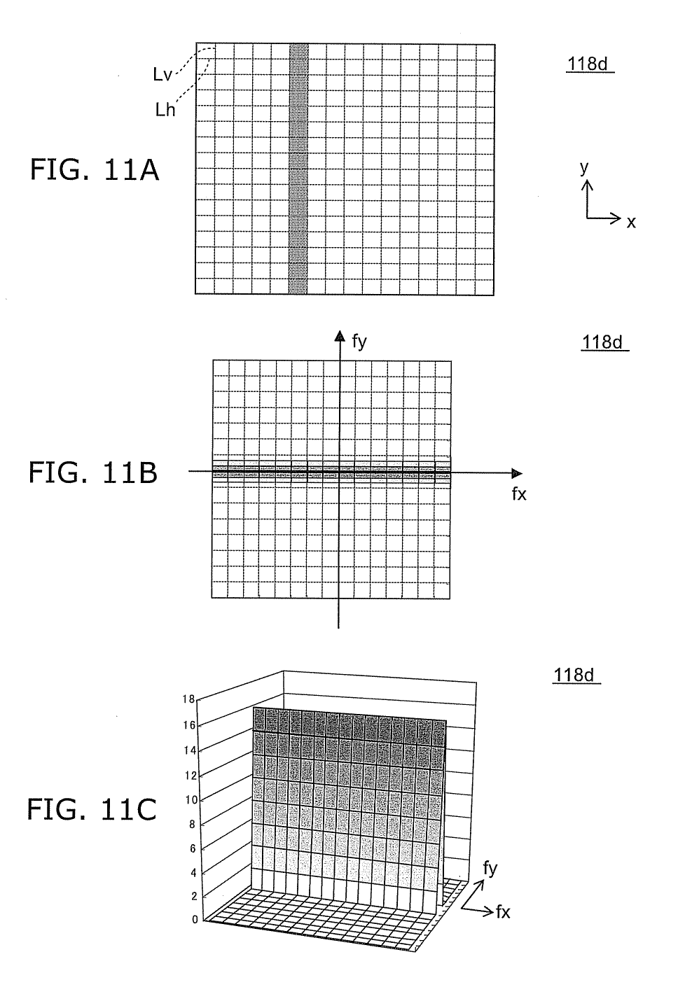

FIG. 8A, FIG. 8B, FIG. 8C, FIG. 9A, FIG. 9B, FIG. 9C, FIG. 10A, FIG. 10B, FIG. 10C, FIG. 11A, FIG. 11B, FIG. 11C, FIG.

12A, FIG. 12B, and FIG. 12C are schematic diagrams illustrating display unevenness in the display device.

The drawings show simulation results of the spatial frequency characteristics of the display unevenness observed when the positions of the connection points between light extraction elements 20e are changed.

As shown in FIG. 8A, in the display surface (the x-y plane) of the display device, each of the pixels corresponds to a region partitioned by a vertical line Lv and a horizontal line Lh. In FIG. 8A, the pixel in which the connection point is provided is indicated by dotted hatching. As described later, the pixel in which the connection point is not provided is not hatched with dots. FIG. 8B shows the spatial frequency fx of display unevenness in the x-axis direction and the spatial frequency fy of display unevenness in the y-axis direction. In FIG. 8B, the portion with high concentration corresponds to the spatial frequency component being large. The vertical axis of FIG. 8C represents the intensity of the spatial frequency.

A first calculation example 118a illustrated in FIG. 8A to FIG. 8C corresponds to a configuration in which the connection point is provided for each of all the pixels. In this case, as shown in FIG. 8B and FIG. 8C, the spatial frequencies fx and fy have only the direct current component (fx=fy=0).

As shown in FIG. 9A, a second calculation example 118b corresponds to a configuration in which the connection point is provided for every three pixels along the x-axis direction. In FIG. 9A, the pixel hatched with dots corresponds to a pixel in which the connection point is provided, and the pixel not hatched with dots corresponds to a pixel in which the connection point is not provided. In this case, there is regularity along the x-axis direction. In this case, as shown in FIG. 9B and FIG. 9C, in the spatial frequencies fx and fy, peaks occur in the direct current component (fx=fy=0) and in the fx component. At this time, vertically striped display unevenness is visible.

As shown in FIG. 10A, a third calculation example 118c corresponds to a configuration in which connection points are provided along an oblique direction. In this case, there is regularity along the x-axis direction and the y-axis direction. In this case, as shown in FIG. 10B and FIG. 10C, strong peaks occur in the spatial frequencies fx and fy. At this time, obliquely striped display unevenness is visible.

As shown in FIG. 11A, in a fourth calculation example 118d, connection points are provided along the y-axis direction. In this case, as shown in FIG. 11B and FIG. 11C, a strong fx component equivalent to the direct current component (fx=fy=0) occurs. The fx component is distributed in a wide frequency range. At this time, vertically lined display unevenness is visible.

As shown in FIG. 12A, a fifth calculation example 118e corresponds to a configuration in which connection points are randomly disposed. In this case, the direct current component (fx=fy=0) is strong, and the intensity of the other plurality of frequency components is relatively low as compared to the direct current component.

In the case where, like the fifth calculation example 118e, the direct current component and the other plurality of frequency components with lower intensity than the direct current component appear in the spatial frequency of the distribution of display unevenness (e.g. the distribution of luminance), display unevenness due to a plurality of frequency components is less likely to be visible. The arrangement of connection points of the fifth calculation example 118e is included in the embodiment.

In a configuration in which the connection point is provided for each of all the pixels like the first calculation example 118a, connection is complicated and this leads to, for example, an increase in cost.

In the embodiment, the length along the Y-axis direction of the plurality of light extraction elements 20e is twice or more the pitch py of the light guide body 10. That is, one light extraction element 20e (and connection point) is provided for a plurality of pixels. Thereby, connecting is simplified, and manufacturing becomes easy. The position between light extraction elements 20e (i.e. the position of the connection point) is uniformly distributed in the display surface (in a plane including the X-axis direction and the Y-axis direction). When the position is uniformly distributed, for example, the direct current component and the other plurality of components with lower intensity than the direct current component appear in the spatial frequency of the distribution of display unevenness (e.g. the distribution of luminance).

The display device 110 according to the embodiment can reduce display unevenness caused by signal delay and can further reduce display unevenness caused by the spatial arrangement of the lead electrodes 25. That is, a display device with a low level of display unevenness and a limited feeling of disturbance can be provided.

An example of the method for manufacturing the display device 110 according to the embodiment will now be described.

As shown in FIG. 3 and FIG. 4, the first electrode 51 and the second electrode 52 are provided on the major surfaces of the first substrate 81 and the second substrate 82, respectively. The first electrode 51 faces the second electrode 52. Furthermore, a conductive paste, for example, is applied to the side surface portions of the first electrode 51 and the second electrode 52 so that the first electrode 51 and the second electrode 52 can be electrically connected from the side surface 10s of the light guide bodies 10. A silver paste, for example, is used as the conductive paste. The conductive paste has, for example, a dot shape and a diameter of, for example, approximately 200 micrometers (μm). The conductive paste forms the lead electrode 25.

The average of the distance between the first electrode 51 and the second electrode 52 is, for example, not less than 10 μm and not more than 50 μm. Specifically, it is 30 μm, for example.

The seal member 24 is formed in a frame shape between the first electrode 51 and the second electrode 52. An entry for injecting a liquid crystal described later is provided in the seal member 24 in a frame shape. The porous body 27a is disposed into the interior surrounded by the first electrode 51, the second electrode 52, and the seal member 24 from the entry. A film-like porous body such as a membrane filter, for example, is used as the porous body 27a. The average diameter of the pore 27c of the porous body 27a is not less than 500 nm.

Furthermore, in the seal member 24, spaces for injecting a liquid crystal material are formed at prescribed intervals along the extending direction of the light extraction unit 20.

Next, a liquid crystal material that forms the polymer dispersed liquid crystal unit 27b is penetrated into the porous body 27a from the plurality of spaces for injection. After that, the liquid crystal material is irradiated with ultraviolet light, and the polymer dispersed liquid crystal unit 27b is formed in the porous body 27a.

In the pore 27c of the porous body 27a thus formed, the liquid crystal droplets 27d with an average diameter of 50 nm or less are formed. Thereby, the liquid crystal dispersion layer 27 is formed. The thickness of the liquid crystal dispersion layer 27 is substantially equal to the distance between the first electrode 51 and the second electrode 52. That is, the average of the thickness of the liquid crystal dispersion layer 27 is, for example, within a range of 10 to 50 μm, and is specifically, for example, 30 μm.

After that, the lead electrode 25 (a conductive paste) formed on the side surface of the light extraction unit 20 is connected by a metal interconnection (the supply line 31).

More specific examples will now be illustrated.

E7 (manufactured by Merck KGaA, no=1.522, ne=1.746) is used as a nematic liquid crystal. NOA81 (manufactured by Norland Products Inc., refractive index: 1.56) is used as an ultraviolet curable resin. A polycarbonate (refractive index: 1.59 to 1.60) is used as the porous body 27a. The mixing ratio of liquid crystal:resin is 30:70. Both are mixed well, and are penetrated into a membrane filter made of a polycarbonate (average pore size: 500 nm, thickness: 20 μm). Then, ultraviolet light (300 mW/cm²) is applied to cure the resin, and the liquid crystal dispersion layer 27 is obtained in which minute liquid crystal droplets 27d are formed in the resin. The average diameter of the liquid crystal droplets 27d is 50 nm, and an aggregate with an average diameter of 500 nm is formed. The liquid crystal dispersion layer 27 is transparent.

The resulting liquid crystal dispersion layer 27 is placed between a pair of transparent substrates in which a transparent electrode of ITO (indium tin oxide) is formed, and the light extraction unit 20 is obtained. The lead electrode 25 is beforehand formed on the side surface portion of the transparent electrode at prescribed intervals. After the light extraction unit 20 is formed, an aluminum interconnection with a diameter of 0.3 mm that forms the supply line 31 is connected to the electrode. When a voltage of 200 V is applied between the transparent electrodes, the liquid crystal dispersion layer 27 becomes a scattering state. The response speed thereof is approximately 20 μsec.

Furthermore, the light extraction unit 20 is brought into orthogonal contact with a plurality of juxtaposed light guide bodies 10 made of an acrylic. A coupling oil with a refractive index of 1.50 is applied to the contact portion of the light guide body 10 so that the light extraction unit 20 may be in optical contact with the light guide body 10. A light emitting diode is disposed as the light source 13 at one end of the light guide body 10. Light 9 is incident on the light guide body 10 from the light emitting diode. In a state where the light extraction unit 20 is transparent (a voltage non-application state), light is not extracted. When a voltage is applied to the electrodes into a scattering state, light is extracted from the light guide body 10. In a transparent state, no light leakage is observed and there is little light loss.

The plurality of light guide bodies 10 including the light source 13 at one end are disposed in the way shown in FIG. 1. Furthermore, the plurality of supply lines 31 are disposed orthogonal to the light guide body 10. A coupling oil is provided between the light extraction unit 20 and the light guide body 10. An ultraviolet curable resin may be used in place of the coupling oil, and the light extraction unit 20 and the light guide body 10 may be fixed after assembly. The positions of the lead electrodes 25 formed on the light extraction unit 20 are shifted in the Y-axis direction so that the lead electrodes 25 may be uniformly disposed in the plane. Thereby, striped unevenness due to the lead electrodes 25 is not observed.

A voltage of 200 V is sequentially applied to the plurality of supply lines 31 (corresponding to scan lines) from the control unit 30, and the light extraction unit 20 is switched to the light extraction state with respect to each of supply lines 31. In synchronization with this, light 9 having a prescribed intensity and color is caused to be incident on the light guide bodies 10 from the plurality of light sources 13. Light is extracted in the light extraction unit 20 connected to the supply line 31 selected by the control unit 30. The operation is performed on all the supply lines 31 by sequentially scanning; thereby, displaying is performed. Uneven brightness in the screen or operational malfunction due to signal delay of the light extraction unit 20 does not occur. The light extraction unit 20 responds quickly in approximately 20 μsec. Therefore, the display device can follow even moving images satisfactorily.

### Second Embodiment

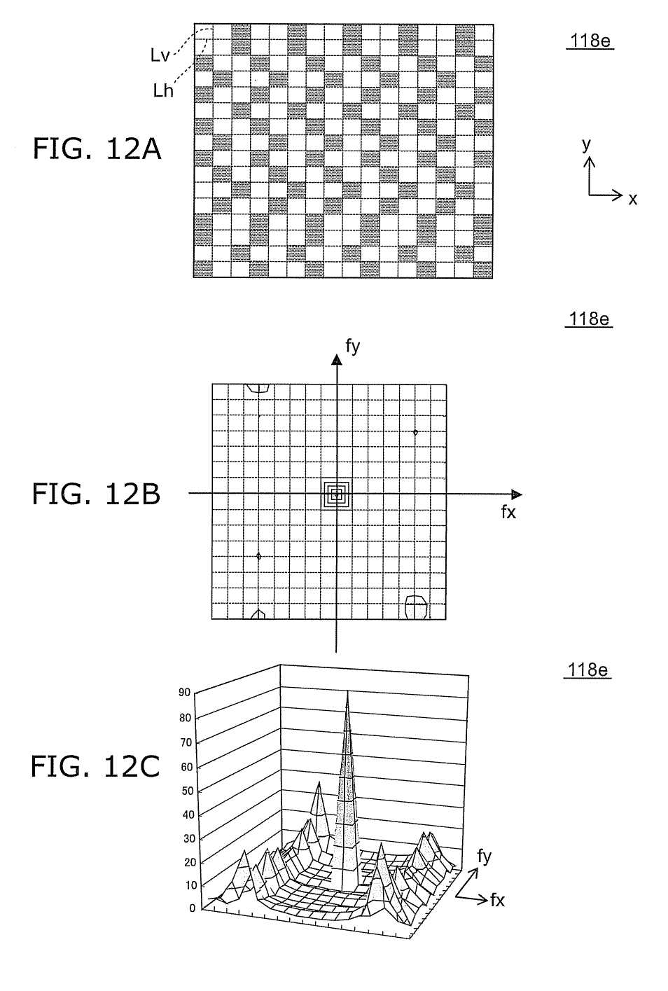

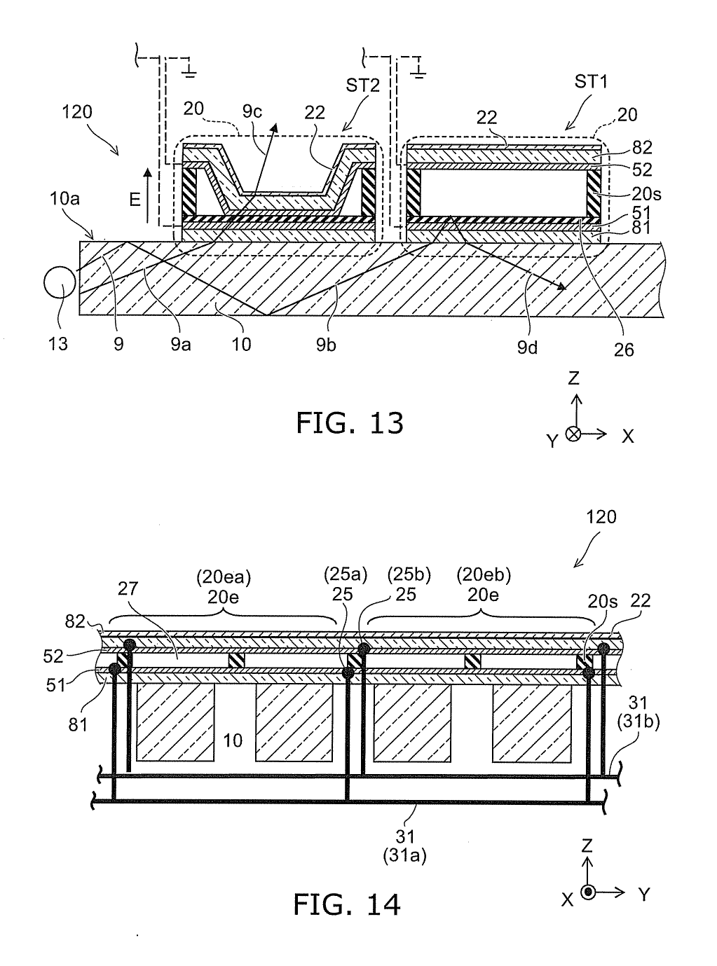

FIG. 13 is a schematic cross-sectional view illustrating the configuration of a display device according to a second embodiment.

FIG. 13 is a cross-sectional view corresponding to the cross section taken along line A1-A2 of FIG. 1.

The entire configuration (planar configuration) of a display device 120 according to the embodiment may be similar to that of the display device 110 illustrated in FIG. 1, and a description is therefore omitted.

In the display device 120 according to the embodiment, the light extraction operation uses a change in the contact state between a film in which a minute displacement occurs due to an electrostatic force and the light guide body 10.

As shown in FIG. 13, the transparent first substrate 81 is disposed in contact with the light guide body 10. The first electrode 51 (e.g. ITO, thickness being 100 nm) is provided on the first substrate 81. Furthermore, an insulating film 26 is provided on the first electrode 51. An acrylic insulating resin, for example, is used for the insulating film 26. The thickness of the insulating film 26 is, for example, 3 μm.

A spacer 20s having a prescribed shape is provided on the insulating film 26. The height of the spacer 20s is, for example, 5 μm. A resist material etc., for example, are used for the spacer 20s.

On the other hand, the second electrode 52 (e.g. ITO, thickness being 100 nm) is provided on the major surface of the transparent second substrate 82. A PI (polyimide) film with a thickness of 100 μm, for example, is used as the second substrate 82. The second substrate 82 is disposed such that the second electrode 52 faces the first electrode 51. In a portion near the spacer 20s, the distance between the first substrate 81 and the second substrate 82 is kept at the height of the spacer 20s. In this state, the second substrate 82 is attached to the spacer 20s by, for example, thermo-compression bonding treatment. The spacer 20s defines the spacing between the first electrode 51 and the second electrode 52. The spacer 20s is provided between pixels, for example.

On the other hand, for example, a minute concavo-convex portion 22 is formed at the surface (the upper surface) of the second substrate 82 on which ITO is not formed.

In the light extraction unit 20 on the right side shown in FIG. 13 (the first state ST1), no voltage is applied between the first electrode 51 and the second electrode 52. In the first state ST1, the light 9b propagated through the light guide body 10 is totally reflected at the insulating film 26 on the surface of the first substrate 81, and is returned to the light guide body 10 (light 9d).

On the other hand, in the light extraction unit 20 on the left side shown in FIG. 13 (the second state ST2), a voltage is applied between the first electrode 51 and the second electrode 52. In the second state ST2, the second substrate 82 is displaced by the electrostatic force between the electrodes, and the second substrate 82 comes into contact with the first substrate 81 (via the second electrode 51, the insulating film 26, and the first electrode 51). The light 9a propagated through the light guide body 10 passes through the first substrate 81 to reach the second substrate 82; further changes its optical travel direction at the concavo-convex portion 22; and then is emitted to the outside as light 9c. That is, the state of the light extraction from the light guide body 10 can be switched by the electric signal supplied to the first electrode 51 and the second electrode 52.

FIG. 14 is a schematic view illustrating the configuration of the display device according to the second embodiment.

FIG. 14 schematically illustrates a cross section corresponding to the cross section taken along line B1-B2 of FIG. 1.

Also in the embodiment using an electrostatic force, delay in the light extraction operation may be caused mainly by the influence of interconnect delay due to the resistance of the electrode. Hence, the supply line 31 is provided, and thereby the interconnect time constant is reduced.

The lead electrode 25 (the first lead electrode 25a and the second lead electrode 25b) is provided on the side surface of each of the first electrode 51 and the second electrode 52. The supply line 31 (the first supply line 31a and the second supply line 31b) is provided to be attached to the light extraction unit 20. The first supply line 31a and the second supply line 31b are connected to the first lead electrode 25a and the second lead electrode 25b, respectively.

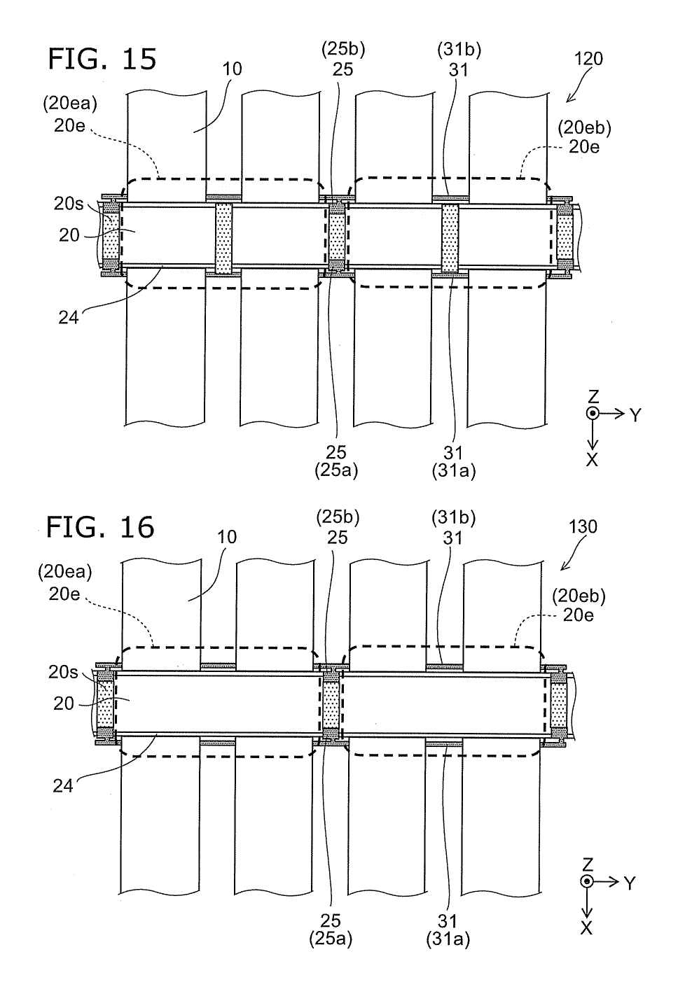

FIG. 15 is a schematic plan view illustrating the configuration of a part of the display device according to the second embodiment.

FIG. 15 illustrates an enlarged view of a portion corresponding to the part PA1 of FIG. 1.

As shown in FIG. 15, in the example, the light extraction unit 20 is disposed between the first supply line 31a and the second supply line 31b.

As a consequence, the resistance along the Y-axis of the electrode of the light extraction unit 20 can be reduced to decrease the interconnect time constant, and delay in light extraction timing can be suppressed.

In the display device 120, for example, light extraction can be performed by applying a voltage between the first electrode 51 and the second electrode 52. The response speed when a voltage of 200 V is applied is approximately 100 μsec.

Also in the display device 120, the plurality of light extraction units 20 may be brought into orthogonal contact with the plurality of light guide bodies 10 via, for example, a coupling oil, and similar operations to the display device 110 can thus be performed.

FIG. 16 is a schematic plan view illustrating the configuration of a part of another display device according to the second embodiment.

FIG. 16 illustrates an enlarged view of a portion corresponding to the part PA1 of FIG. 1 in regard to another display device 130 according to the embodiment. As illustrated in FIG. 16, the spacer 20s is disposed between pixels. FIG. 16 shows a portion in which one spacer 20s is provided for two pixels. The spacer 20s forms a partition between light extraction elements 20e. The spacer 20s is provided between light extraction elements 20e.

The position (the position between light extraction elements 20e) of the spacer 20s is uniformly distributed in the display surface (in a plane including the X-axis direction and the Y-axis direction). Thereby, display unevenness can be suppressed.

In the first and second embodiments, the position between light extraction elements 20e needs only to be uniformly distributed in the X-Y plane, and the length along the Y-axis direction of each of the plurality of light extraction elements 20e may be different from one another, for example.

In the first and second embodiments, the cross section (the cross section when cut along the Z-Y plane) of the light guide body 10 may be, for example, a quadrangle, circle, ellipse, etc. However, the first and second embodiments are not limited thereto, and the shape of the cross section of the light guide body 10 is arbitrary.

The embodiment provides a display device with reduced display unevenness.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, embodiments of the invention are described with reference to specific examples. However, the embodiment of the invention is not limited to these specific examples. For example, one skilled in the art may appropriately select specific configurations of components of display devices such as light guide bodies, light sources, light extraction units, control units, lead electrodes, supply lines, substrates, electrodes, liquid crystal dispersion layers, insulating films, and spacers from known art and similarly practice the invention. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all display devices that can be obtained by an appropriate design modification by one skilled in the art based on the display devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A display device comprising:
a plurality of light guide bodies extending along a first direction, each of the light guide bodies including one end, another end on an opposite side to the one end, and a side surface extending along the first direction, the light guide bodies being disposed along a second direction orthogonal to the first direction with a pitch,
a plurality of light sources, each plurality of the light sources being juxtaposed to the one end of each of the light guide bodies, the light sources being configured to cause a light to enter the light guide bodies from the one end;
a plurality of light extraction units, each of the light extraction units facing the side surface of each of the light guide bodies and including a plurality of light extraction elements disposed along the second direction, the light extraction units being disposed along the first direction; and
a control unit configured to supply an electric signal to each of the light extraction units and make the light extraction units extract the light that enters the light guide bodies and propagates through the light guide bodies, from the light guide bodies to an outside of the light guide bodies in accordance with the electric signal,
a length along the second direction of the light extraction elements being twice or more the pitch, positions between the light extraction elements being uniformly distributed in a plane including the first direction and the second direction.

2. The device according to claim 1, wherein the length along the second direction of the light extraction elements is a two or more integral multiple of the pitch.

3. The device according to claim 2, wherein the length along the second direction of the light extraction elements is a 100 or less integral multiple of the pitch.

4. The device according to claim 2, further comprising supply lines, each of the supply lines being attached to each of the light extraction units and configured to supply the electric signals to each of the light extraction elements.

5. The device according to claim 4, wherein the supply lines are configured to supply a current to each of the light extraction elements at positions between the light extraction elements.

6. The device according to claim 5, wherein the supply lines contain at least one of aluminum and copper.

7. The device according to claim 1, wherein the light extraction units include:
a first transparent substrate;
a second transparent substrate facing the first transparent substrate along a third direction perpendicular to the first direction and the second direction;
a first electrode provided between the first transparent substrate and the second transparent substrate and being transparent;
a second electrode provided between the first transparent substrate and the second transparent substrate and being transparent; and
a liquid crystal dispersion layer provided between the first electrode and the second electrode.

8. The device according to claim 7, wherein the liquid crystal dispersion layer includes:
a porous body having a pore; and
a polymer dispersed liquid crystal unit provided in the pore.

9. The device according to claim 8, wherein an average diameter of the pore is not less than 500 nanometers.

10. The device according to claim 7, wherein
the light extraction units further include a plurality of first lead electrodes disposed along the second direction and connected to a side surface of the first electrode,
a length along the second direction of a spacing between the first lead electrodes is a two or more integral multiple of the pitch.

11. The device according to claim 10, wherein the length along the second direction of the spacing between the first lead electrodes is a 100 or less integral multiple of the pitch.

12. The device according to claim 11, wherein
the light extraction units further include a plurality of second lead electrodes disposed along the second direction and connected to a side surface of the second electrode,
a length along the second direction of a spacing between the second lead electrodes is 2 or more integral multiple of the pitch.

13. The device according to claim 12, wherein the length along the second direction of the spacing between the second lead electrodes is 100 or less integral multiple of the pitch.

14. The device according to claim 7, wherein an average distance between the first electrode and the second electrode is not less than 10 micrometers and not more than 50 micrometers.

15. The device according to claim 1, wherein a spatial frequency of an intensity distribution of a light emitted from the light guide bodies along a third direction perpendicular to the first direction and the second direction has a direct current component and other plurality of components relatively lower than the direct current component.

16. The device according to claim 1, wherein the light extraction units include:
a first electrode;
a second electrode facing the first electrode; and
a plurality of spacers provided between the light extraction elements to define a spacing between the first electrode and the second electrode.

17. The device according to claim 16, wherein
the light extraction units further include a first transparent substrate and a second transparent substrate,
the first electrode is provided between the first transparent substrate and the second transparent substrate and
the second electrode is disposed between the first electrode and the second transparent substrate.

18. The device according to claim 17, wherein
at least one of the first transparent substrate and the second transparent substrate is a resin film.

19. The device according to claim 17, wherein the spacing between the first transparent substrate and the second transparent substrate is changeable by a voltage applied to the extraction.

20. The device according to claim 19, wherein the change of the spacing is generated by an electrostatic force applied between the first electrode and the second electrode based on the voltage.
